(19) United States
(12) Patent Application Publication
(10) Pub. No.: US 2013/0071763 A1
(43) Pub. Date: Mar. 21, 2013

(54) PEM FUEL CELL SYSTEM WITH HYDROGEN SEPARATION FROM A REFORMATE CONTAINING CARBON MONOXIDE

(71) Applicant: Daniel Betts, Parkland, FL (US)

(72) Inventor: Daniel Betts, Parkland, FL (US)

(73) Assignee: EnerFuel, Inc., West Palm Beach, FL (US)

(21) Appl. No.: 13/234,445

(22) Filed: Sep. 16, 2011

(51) Int. Cl. H01M 8/06; H01M 8/24; H01M 8/04; H01M 8/10

(52) U.S. Cl. 429/411; 429/413

(57) ABSTRACT

A fuel cell system is disclosed having at least a first section that operates in a hydrogen filtration mode to filter an incoming hydrogen-rich fuel, specifically a reformate, and at least a second section that operates in a power generation mode. The second section may receive filtered hydrogen fuel from the first section. Also, to rejuvenate the first section after anode poisoning, the first section may switch modes to operate in the power generation mode.

### FIELD

The present disclosure relates to a fuel cell system. More specifically, the present disclosure relates to a fuel cell system that separates hydrogen from a reformate gas containing carbon monoxide.

### BACKGROUND

Fuel cells generate electrical power for use in a variety of applications. For example, fuel cells serve as power generators for stationary applications, such as houses, apartments, and telecommunication towers. Eventually, fuel cells may also serve as power generators for mobile applications, such as motor vehicles, replacing internal combustion engines in motor vehicles.

A fuel cell is shown in FIG. 1 having an anode, a cathode, and an ion-exchange membrane, which acts as a solid electrolyte, between the anode and the cathode. The membrane may be in the form of a proton-exchange membrane (PEM). Hydrogen-rich (H₂) fuel is supplied to the anode and oxygen-rich (O₂) air is supplied to the cathode. The H₂ reacts in the presence of a catalyst (e.g., platinum) at the anode to form positively charged hydrogen ions (H⁺), which travel to the cathode through the PEM, and negatively charged electrons (e), which travel to the cathode via a wire to create an electrical current. Upon reaching the cathode, the materials react to form water vapor (H₂O), which is removed from the fuel cell.

An ideal fuel for current PEM fuel cells is pure hydrogen. However, hydrogen does not exist naturally in elemental form and, in many applications, is generated from a primary fuel (e.g., natural gas, methane, methanol, gasoline) through a hydrocarbon reforming process. The reformate fuel produced by such reforming processes may include the desired hydrogen fuel, as well as unwanted gaseous byproducts, such as carbon monoxide, carbon dioxide, nitrogen, ammonium, and hydrogen sulfide, for example. These gaseous byproducts may hinder performance of the fuel cell by diluting the hydrogen concentration of the reformate fuel. The carbon monoxide byproduct, in particular, may further hinder performance of the fuel cell by poisoning the anode's catalyst.

Efforts have been made to improve the reforming process itself, such as by using special reforming catalysts. However, due to variations in fuel introduction rates, temperature, and pressure, the quality of the produced reformate varies.

Efforts have also been made to clean-up the produced reformate fuel, such as using preferential oxidation (PROX) reactors, low temperature water-gas shift reactors, and palladium membrane filters. The effectiveness of PROX reactors and low temperature water-gas shift reactors varies significantly with small variations in inlet reformate gas concentrations and other difficult-to-control variables, which significantly complicates system design. Palladium membrane filters are susceptible to thermally induced stresses, sealing problems, and membrane failure, and also require high pressure differentials leading to pressure losses.

### SUMMARY

The present disclosure provides a fuel cell system having at least a first section that operates in a hydrogen filtration mode to filter an incoming hydrogen-rich fuel, specifically a reformate, and at least a second section that operates in a power generation mode. The second section may receive filtered hydrogen fuel from the first section. Also, to rejuvenate the first section after anode poisoning, the first section may switch modes to operate in the power generation mode.

According to an embodiment of the present disclosure, a fuel cell system is provided for use with a fuel source that supplies hydrogen-rich fuel and carbon monoxide and an air source that supplies oxygen-rich air and water vapor. The fuel cell system includes at least one fuel cell that is selectively operable in a hydrogen filtration mode and in a power generation mode. The at least one fuel cell includes: a first electrode; a second electrode; a membrane positioned between the first and second electrodes; a primary flow field adjacent to the first electrode, the primary flow field being selectively coupled to the fuel source in the hydrogen filtration mode such that at least a portion of the carbon monoxide supplied by the fuel source deposits onto the first electrode, the primary flow field being selectively coupled to the air source in the power generation mode such that at least a portion of the water vapor supplied by the air source reacts with the deposited carbon monoxide; and a hydrogen flow field adjacent to the second electrode.

According to another embodiment of the present disclosure, a fuel cell system is provided for use with a hydrogen-rich fuel source and an oxygen-rich air source. The fuel cell system includes: a hydrogen recirculation loop; at least one hydrogen filtration fuel cell; and at least one power generation fuel cell. The at least one hydrogen filtration fuel cell includes: a first electrode; a second electrode; a membrane positioned between the first and second electrodes; a primary flow field adjacent to the first electrode, the primary flow field having an inlet in communication with the hydrogen-rich fuel source; and a hydrogen flow field adjacent to the second electrode, the hydrogen flow field having an outlet in communication with the hydrogen recirculation loop to deliver filtered hydrogen to the hydrogen recirculation loop. The at least one power generation fuel cell includes: a first electrode; a second electrode; a membrane positioned between the first and second electrodes; a primary flow field adjacent to the first electrode, the primary flow field having an inlet in communication with the oxygen-rich air source; and a hydrogen flow field adjacent to the second electrode, the hydrogen flow field having an inlet in communication with the hydrogen recirculation loop and an outlet in communication with the hydrogen recirculation loop.

According to yet another embodiment of the present disclosure, a method is provided for operating a fuel cell system, the fuel cell system including a hydrogen filtration fuel cell having an anode, a cathode, a membrane positioned between the anode and the cathode, and a power source electrically coupled to the cathode. The method includes the steps of: directing a hydrogen-rich fuel to the anode of the hydrogen filtration fuel cell, the hydrogen in the fuel dissociating into positively charged hydrogen ions; and controlling an electrical current between the power source and the cathode to electrochemically pump a proportional number of the positively charged hydrogen ions across the membrane of the hydrogen filtration fuel cell from the anode to the cathode.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a schematic diagram of a conventional fuel cell operating in a power generation mode;

FIG. 2A is a schematic diagram of a first fuel cell system, the first fuel cell system including a first section operating in a hydrogen filtration mode and second, third, and fourth sections operating in a power generation mode;

FIG. 2B is another schematic diagram of the first fuel cell system, the first section switching modes from FIG. 2A to operate in the power generation mode, the second section switching modes from FIG. 2A to operate in the hydrogen filtration mode, and the third and fourth sections remaining in the same power generation mode as FIG. 2A;

FIG. 3A is a detailed schematic diagram showing the first section of FIG. 2A operating in the hydrogen filtration mode;

FIG. 3B is a detailed schematic diagram showing the second, third, or fourth section of FIG. 2A operating in the power generation mode;

FIG. 4A is a more detailed schematic diagram showing the first section of FIG. 2A operating in the hydrogen filtration mode;

FIG. 4B is a more detailed schematic diagram showing the first section of FIG. 2B operating in the power generation mode;

FIG. 5A is a schematic diagram of a second fuel cell system, the second fuel cell system including a first section operating in a hydrogen filtration mode and second, third, and fourth sections operating in a power generation mode; and

FIG. 5B is another schematic diagram of the second fuel cell system, the first section switching modes from FIG. 5A to operate in the power generation mode, the second section switching modes from FIG. 5A to operate in the hydrogen filtration mode, and the third and fourth sections remaining in the same power generation mode as FIG. 5A.

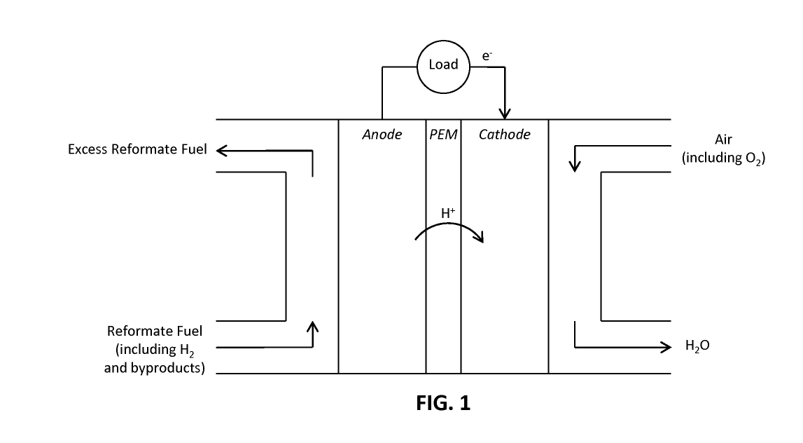

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

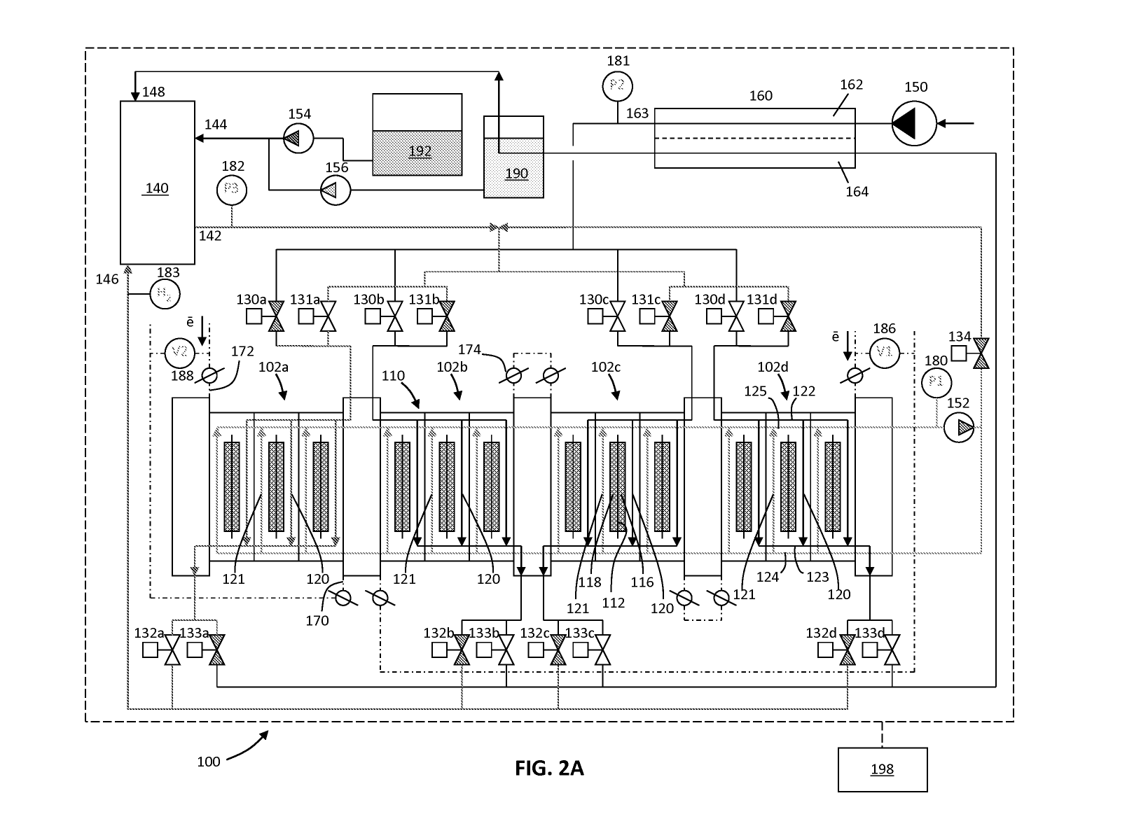

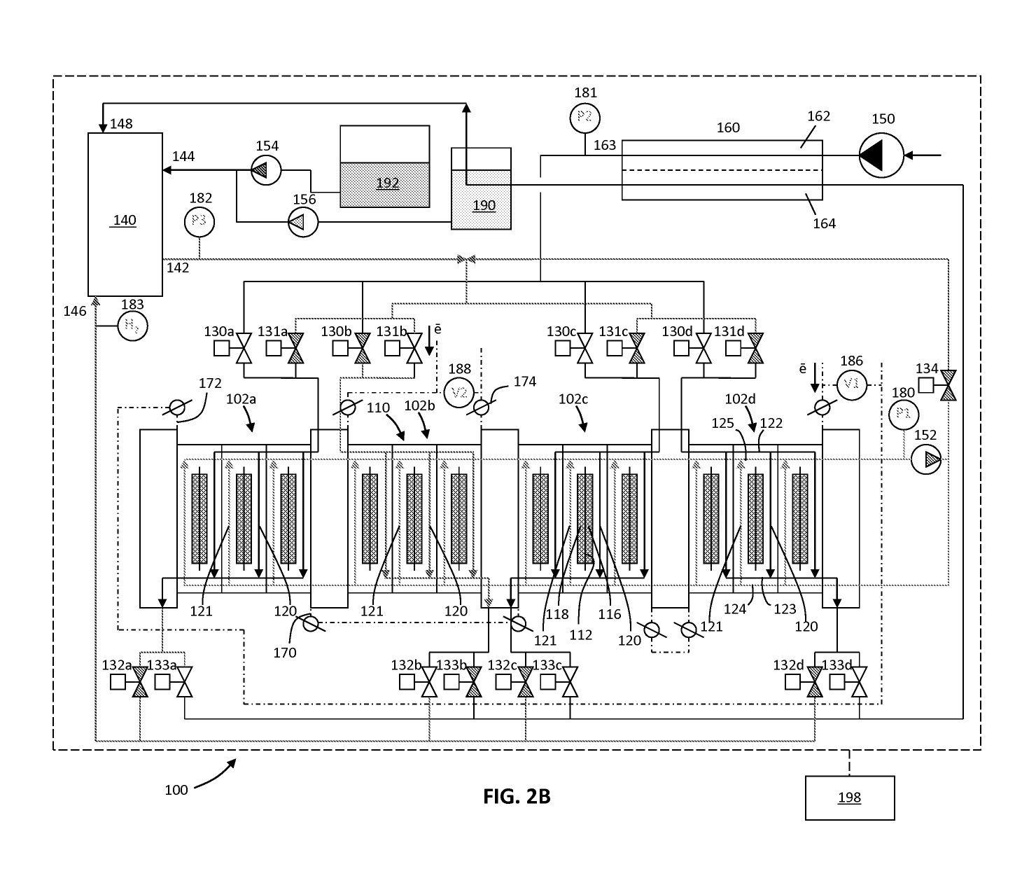

A first fuel cell system 100 is shown in FIGS. 2A and 2B. The first fuel cell system 100 includes a plurality of sections, illustratively four (4) sections 102a, 102b, 102c, 102d. Each section 102a, 102b, 102c, 102d, includes at least one fuel cell 110, illustratively three (3) fuel cells 110. Fuel cells 110 may also be referred to herein as membrane/electrode assemblies, because each fuel cell 110 includes an ion-exchange membrane 112, a first electrode 116 on one side of membrane 112, and a second electrode 118 on the opposite side of membrane 112.

According to an exemplary embodiment of the present disclosure, membrane 112 comprises a proton-exchange membrane (PEM). It is also within the scope of the present disclosure that membrane 112 may comprise an alkaline electrolyte or a phosphoric acid electrolyte, for example.

Referring still to FIGS. 2A and 2B, the first electrode 116 of each fuel cell 110 faces a primary flow field 120 that extends between a primary inlet manifold 122 and a primary exhaust manifold 123. The second electrode 118 of each fuel cell 110 faces a hydrogen flow field 121 that extends between a hydrogen inlet manifold 124 and a hydrogen exhaust manifold 125. The primary flow field 120 and the hydrogen flow field 121 may extend in parallel and may point in opposite directions, as shown in FIGS. 2A and 2B, or in the same direction.

Each section 102a, 102b, 102c, 102d, of the first fuel cell system 100 also includes bus plates 170, 172, with each bus plate 170, 172, having an external electrical terminal 174. Bus plate 170 is located adjacent to the last fuel cell 110 of each section 102a, 102b, 102c, 102d, and bus plate 172 is located adjacent to the first fuel cell 110 of each section 102a, 102b, 102c, 102d.

Fuel cell system 100 includes a source of hydrogen-rich fuel, illustratively a steam reformer 140. Reformer 140 includes a primary fuel inlet 144, a burner fuel inlet 146, a burner air inlet 148, and a fuel outlet 142. The primary fuel inlet 144 of reformer 140 receives a mixture of water from a water trap 190 (via a water pump 156) and primary fuel (e.g., natural gas, methane, methanol, gasoline) from a primary fuel tank 192 (via a primary fuel pump 154). The water and the primary fuel from the primary fuel inlet 144 are consumed in reformer 140 to produce the hydrogen-rich reformate fuel, which is then delivered from the fuel outlet 142. As shown in FIG. 2A, the burner fuel inlet 146 of reformer 140 accommodates a hydrogen sensor 183, and the fuel outlet 142 of reformer 140 accommodates a pressure sensor 182.

The fuel outlet 142 of reformer 140 is in selective communication with each primary flow field 120. In operation, the hydrogen-rich reformate fuel flows from the fuel outlet 142 of reformer 140, through any open solenoid valves 131a, 131b, 131c, 131d (shown in white), and to the corresponding primary flow fields 120.

The hydrogen inlet manifold 124 and the hydrogen exhaust manifold 125 of the first fuel cell system 100 are connected in a hydrogen recirculation loop having a pressure sensor 180 and a recirculation pump 152. By leaving a purge needle valve 134 closed (shown in gray), hydrogen in the hydrogen exhaust manifold 125 recirculates into the hydrogen inlet manifold 124. By opening the purge needle valve 134, hydrogen in the hydrogen exhaust manifold 125 is purged from the hydrogen recirculation loop and mixes with the hydrogen-rich reformate fuel in the fuel outlet 142 of reformer 140.

Additionally, fuel cell system 100 includes a source of oxygen-rich air, such as air compressor 150. Like reformer 140, air compressor 150 is also in selective communication with each primary flow field 120. In operation, air travels through an air feed compartment 162 of humidifier 160, through an air outlet 163, which is equipped with pressure sensor 181, through any open solenoid valves 130a, 130b, 130c, 130d (shown in white), and to the corresponding primary inlet manifold 122 of each desired primary flow field 120. Upon reaching the primary exhaust manifold 123 of each primary flow field 120, the air flows through any open solenoid valves 133a, 133b, 133c, 133d (shown in white), through an air exhaust compartment 164 of humidifier 160, through water trap 190, and into the burner air inlet 148 of reformer 140.

One or more sections of the first fuel cell system 100 operates in a hydrogen filtration mode, illustratively section 102a in FIG. 2A, to remove impurities from the incoming supply of reformate fuel and to produce a filtered supply of pure or substantially pure hydrogen. In FIG. 2A, solenoid valves 131a and 132a of section 102a are open (shown in white), solenoid valves 130a and 133a of section 102a are closed (shown in gray), and the negative and positive terminals of an internal power supply (not shown in FIG. 2A) are connected to electrical terminals 174 of bus plates 170, 172, respectively. As a result, the hydrogen-rich reformate fuel flows from the fuel outlet 142 of reformer 140, through the open solenoid valve 131a (shown in white), and into the primary flow field 120 of section 102a.

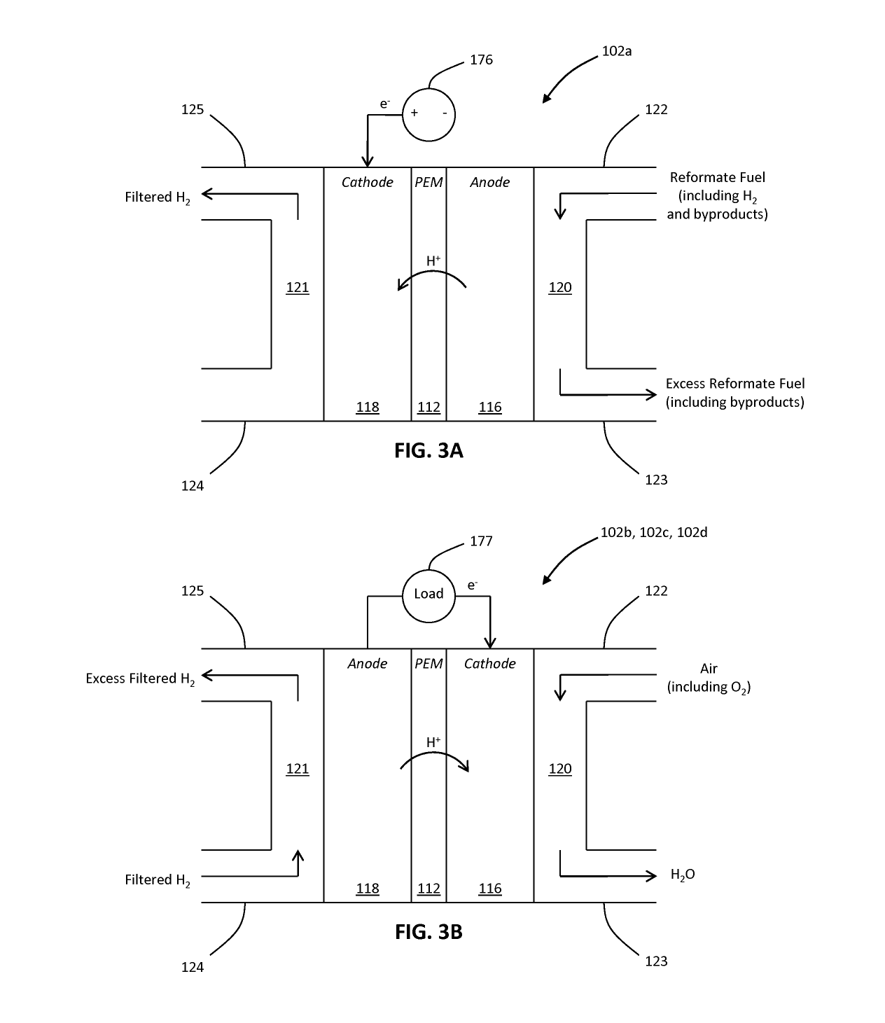

FIG. 3A shows section 102a in more detail while operating in the hydrogen filtration mode. Under the supplied current from power supply 176, the adjacent first electrode 116 serves as the anode and the opposing second electrode 118 serves as the cathode. Hydrogen in the reformate fuel dissociates at the first electrode 116 into positively charged hydrogen ions and negatively charged electrons, according to Reaction (1) below:

H₂+Pt(catalyst)→2H⁺+2e⁻ (1)

The positively charged hydrogen ions are electrochemically pumped across membrane 112 from the first electrode 116 to the second electrode 118. Upon reaching the hydrogen flow field 121, the positively charged hydrogen ions join with negatively charged electrons from power supply 176 to produce filtered hydrogen, according to Reaction (2) below:

2e⁻+2H⁺→H₂ (2)

As a result of Reaction (2), the hydrogen flow field 121 of section 102a will contain pure or substantially pure hydrogen, and the primary flow field 120 will contain the undesired reformate byproducts, which may include carbon monoxide, carbon dioxide, and other diluent gases. Thus, the undesired reformate byproducts are separated from the filtered hydrogen. The purity of the filtered hydrogen in the hydrogen flow field 121 may be evaluated using gas chromatography.

Returning to FIG. 2A, excess, unfiltered, reformate fuel in the primary flow field 120 of section 102a continues to the primary exhaust manifold 123, through the open solenoid valve 132a (shown in white), and into the burner fuel inlet 146 of reformer 140. The excess fuel may contain a high concentration of hazardous carbon monoxide. By sending the carbon monoxide back to reformer 140, the carbon monoxide may be burned to produce heat for additional fuel reformation. Also, the carbon monoxide may be oxidized to produce non-hazardous carbon dioxide.

One or more other sections of the first fuel cell system 100 operate in a power generation mode, illustratively sections 102b, 102c, 102d, in FIG. 2A. In this embodiment, power is generated continuously by sections 102b, 102c, 102d, and at the same time, the reformate fuel is filtered continuously by section 102a. As shown in FIG. 2A, solenoid valves 130b, 130c, 130d, and 133b, 133c, 133d, of sections 102b, 102c, 102d, are open (shown in white), solenoid valves 131b, 131c, 131d, and 132b, 132c, 132d, of sections 102b, 102c, 102d, are closed (shown in gray), and sections 102b, 102c, 102d, are electrically connected in series or in parallel with electrical terminals 174 of bus plates 170, 172, which are in turn connected to an external load (not shown in FIG. 2A). As a result, air from compressor 150 and humidifier 160 flows via the air outlet 163, through the open solenoid valves 130b, 130c, 130d (shown in white), and into the primary flow fields 120 of sections 102b, 102c, 102d.

According to an exemplary embodiment of the present disclosure, filtered hydrogen from the section(s) operating in the hydrogen filtration mode is supplied to the section(s) operating in the power generation mode. In conventional fuel cells, the supply reformate fuel may have a hydrogen concentration as low as 40% or 60% and a carbon monoxide concentration as high as 100 ppm or 200 ppm. Due to hydrogen dilution in the reformate fuel and anode catalyst poisoning by the reformate fuel, a conventional PEM hydrogen fuel cell operating at current density of 0.5 A/cm² may suffer voltage reductions of 200 mV, 300 mV, or more. By contrast, in fuel cell system 100 of the present disclosure, the supply of filtered hydrogen may have a hydrogen concentration of about 90% or more, more preferably about 95% or more, and even more preferably about 100%. Compared to a conventional fuel cell, fuel cell system 100 of the present disclosure may have improved fuel cell efficiency and improved power generation. For example, fuel cell system 100 of the present disclosure may be about 40% more efficient than a conventional fuel cell.

In the illustrated embodiment of FIG. 2A, filtered hydrogen from section 102a operating in the hydrogen filtration mode is supplied to sections 102b, 102c, 102d, operating in the power generation mode. From section 102a, the filtered hydrogen flows to the hydrogen exhaust manifold 125, and is then recirculated to the hydrogen inlet manifold 124 via recirculation pump 152. In sections 102b, 102c, 102d, the filtered and recirculated hydrogen flows from the hydrogen inlet manifold 124 to the hydrogen flow fields 121 opposite the primary flow fields 120.

FIG. 3B shows one of sections 102b, 102c, 102d, in more detail while operating in the power generation mode. Absent power supply 176 (FIG. 3A), first electrode 116 serves as the cathode and second electrode 118 serves as the anode. Hydrogen in the filtered fuel dissociates at the second electrode 118 into positively charged hydrogen ions and negatively charged electrons, according to Reaction (3) below:

H₂→2H⁺+2e⁻ (3)

The positively charged hydrogen ions travel to the first electrode 116 through membrane 112, and the negatively charged electrons travel to the first electrode 116 across a wire to power load 177. Upon reaching the first electrode 116, the positively charged hydrogen ions and the negatively charged electrons electrochemically react with the oxygen-rich air in the primary flow field 120 to form water vapor, according to Reaction (4) below:

O₂+4H⁺+4e⁻→2H₂O (4)

Returning to FIG. 2A, excess air in the primary flow fields 120, now depleted in oxygen and enriched with water vapor, flows to the primary exhaust manifold 123, through the open solenoid valves 133b, 133c, 133d (shown in white), and through the air exhaust compartment 164 of humidifier 160 to humidify or moisten incoming air in the air feed compartment 162 of humidifier 160. Then, the air flows through water trap 190 to remove water. Finally, the air flows into the burner air inlet 148 of reformer 140, which uses oxygen in the air to oxidize hydrogen and carbon monoxide.

The supply of hydrogen-rich reformate fuel from reformer 140 may be controlled, such as by controlling operation of the water pump 156 and the primary fuel pump 154. In one embodiment, the water pump 156 and the primary fuel pump 154 are controlled based on the pressure of the hydrogen-rich fuel detected by the pressure sensor 182 at the fuel outlet 142 of reformer 140. In another embodiment, the water pump 156 and the primary fuel pump 154 are controlled based on the amount of excess hydrogen detected by the hydrogen sensor 183 at the burner fuel inlet 146 of reformer 140. In yet another embodiment, the water pump 156 and the primary fuel pump 154 are controlled based on the performance of the section(s) operating in the hydrogen filtration mode, illustratively section 102a in FIG. 2A. The performance of section 102a may be determined by measuring the voltage “V2” across section 102a using voltage sensor 188, for example. It is also within the scope of the present disclosure that more than one of the above-described techniques may be used to control the supply of hydrogen-rich reformate fuel from reformer 140.

The supply of filtered hydrogen may also be controlled, such as by controlling the electrical current supplied to the section(s) operating in the hydrogen filtration mode, illustratively section 102a in FIG. 2A. In FIG. 3A, for example, the electrical current supplied to section 102a from power supply 176 may be controlled. The amount of hydrogen that is electrochemically pumped across membrane 112 of section 102a will be directly proportional to the electrical current supplied to section 102a. Thus, if more filtered hydrogen is needed, the electrical current supplied by power supply 176 to section 102a is increased proportionately, and if less filtered hydrogen is needed, the electrical current supplied by power supply 176 to section 102a is decreased proportionately. In one embodiment, the electrical current is controlled based on the pressure of the filtered hydrogen detected by the pressure sensor 180 in the hydrogen recirculation loop. In this manner, a predetermined amount of filtered hydrogen may be produced and maintained in the hydrogen recirculation loop, even if the amount of filtered hydrogen consumed by the section(s) operating in the power generation mode varies.

Although the supplied electrical current is directly proportional to the amount of hydrogen that is electrochemically pumped across section 102a, the voltage across section 102a varies relative to the amount of hydrogen that is electrochemically pumped across section 102a. For example, as a higher current is applied and more hydrogen is electrochemically pumped across section 102a, the voltage across section 102a will drop due to activation, ohmic, and concentration losses, for example. At a supplied current density of 0.5 A/cm², for example, the voltage across section 102a may vary between about 50 mV and about 100 mV.

The quality of the filtered hydrogen in fuel cell system 100 may also be controlled, such as by periodically and selectively opening the purge needle valve 134. As impurities or byproducts accumulate in the hydrogen recirculation loop, the hydrogen fuel supplied to the section(s) operating in the power generation mode, illustratively sections 102b, 102c, 102d, in FIG. 2A, will become diluted, and the performance of sections 102b, 102c, 102d, will suffer. Therefore, in one embodiment, the purge needle valve 134 is controlled based on the performance of sections 102b, 102c, 102d, such as by measuring the voltage “V1” across sections 102b, 102c, 102d using voltage sensor 186. By opening the purge needle valve 134, at least a portion of the hydrogen in the hydrogen recirculation loop is purged from the hydrogen recirculation loop. The purged hydrogen mixes with the incoming, hydrogen-rich reformate fuel from the fuel outlet 142 of reformer 140. The mixed stream is then directed to a section operating in the hydrogen filtration mode, illustratively section 102a in FIG. 2A, which will remove the accumulated impurities from the purged hydrogen. The purge needle valve 134 may remain open until the performance of sections 102b, 102c, 102d, is restored.

According to an exemplary embodiment of the present disclosure, the section(s) operating in the hydrogen filtration mode are configured to selectively switch into the power generation mode. For example, section 102a operates in the hydrogen filtration mode in FIG. 2A and switches to the power generation mode in FIG. 2B. Also, the section(s) operating in the power generation mode are configured to selectively switch into the hydrogen filtration mode. For example, section 102b operates in the power generation mode in FIG. 2A and switches to the hydrogen filtration mode in FIG. 2B. The sections may change operating modes simultaneously or substantially simultaneously to minimize downtime of fuel cell system 100. At any given time, a controller 198, such as a suitably-programmed computer, may dictate which sections are operating in the hydrogen filtration mode and which sections are operating in the power generation mode.

During the switch, some section(s) may remain in the same operating mode. For example, while sections 102a, 102b, switch operating modes in FIGS. 2A and 2B, sections 102c, 102d, remain in the power generation mode in both FIGS. 2A and 2B.

The above-described switch may involve redirecting material flow paths in fuel cell system 100 and rearranging electrical connections in fuel cell system 100. These steps may be performed by the above-described controller 198 and/or a series of relays that direct electrical current to appropriate components. For example, with reference to FIGS. 2A and 2B, switching section 102a from the hydrogen filtration mode (FIG. 2A) to the power generation mode (FIG. 2B) and switching section 102b from the power generation mode (FIG. 2A) to the hydrogen filtration mode (FIG. 2B) involves closing solenoid valves 131a, 132a, 130b, 133b (shown switching from white to gray), and opening solenoid valves 130a, 133a, 131b, 132b (shown switching from gray to white). With respect to section 102a, the illustrated switch also involves disconnecting the power supply (not shown in FIG. 2A) from electrical terminals 174 of bus plates 170, 172 and electrically connecting bus plates 170, 172, in series with the other sections 102c, 102d, operating in the power generation mode, as shown in FIG. 2B. With respect to section 102b, the illustrated switch also involves connecting the power supply (not shown in FIG. 2B) to electrical terminals 174 of bus plates 170, 172.

In addition to controlling the operation of solenoid valves 130a-130d, 131a-131d, 132a-132d, 133a-133d and the electrical connections of bus plates 170, 172, as discussed above, controller 198 may also control purge needle valve 134, air compressor 150, recirculation pump 152, primary fuel pump 154, and/or water pump 156, for example. Controller 198 may respond to inputs received from pressure sensors 180, 181, 182, hydrogen sensor 183, and/or voltage sensors 186, 188, for example, to control these process parameters.

A switch may be triggered based on the deteriorating performance of the section(s) operating in the hydrogen filtration mode, illustratively section 102a in FIG. 2A. In one embodiment, a switch is triggered when voltage sensor 188 measures a voltage “V2” across section 102a that exceeds a predetermined, threshold voltage. In another embodiment, a switch is triggered when the power supplied to section 102a becomes too large relative to the power generated by the sections 102b, 102c, 102d.

The deteriorating performance of section 102a may indicate that the first electrode 116 has become poisoned by impurities or byproducts in the incoming reformate, such as carbon monoxide (see FIG. 3A). For example, as carbon monoxide occupies more and more sites on the first electrode 116 that are intended for hydrogen, the voltage “V2” of section 102a will increase. Carbon monoxide poisoning may be especially problematic at the relatively low operating temperatures of the present PEM fuel cell system 100, which may be as low as about 60° C., 80° C., 100° C., or 120° C. and as high as about 140° C., 160° C., 180° C., or 200° C. An exemplary PEM fuel cell system 100 operates between about 100° C. and about 200° C., and more specifically between about 120° C. and about 180° C., for example. By contrast, carbon monoxide poisoning may be less problematic at the relatively high operating temperatures of protonic ceramic fuel cells and solid oxide fuel cells, which may be between about 500° C. and 1000° C. At such high operating temperatures, the carbon monoxide may be converted to fuel rather than staying behind to poison the fuel cell.

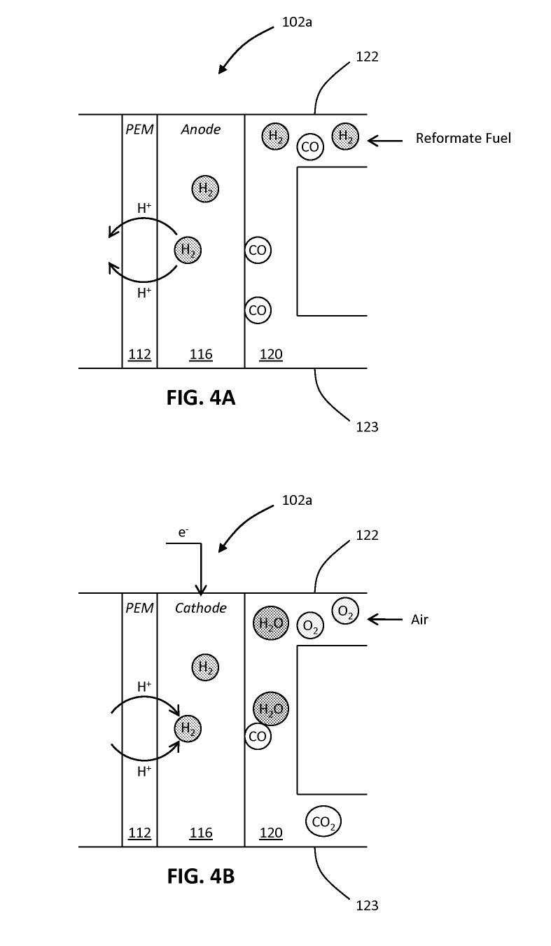

Advantageously, switching from the hydrogen filtration mode to the power generation mode may rejuvenate the once-poisoned section(s). This result is illustrated schematically in FIGS. 4A and 4B. When section 102a is operating in the hydrogen filtration mode (FIG. 4A), the first electrode 116 interacts with the incoming reformate fuel, which may contain carbon monoxide (CO). As hydrogen in the reformate fuel filters across section 102a, carbon monoxide is left behind to poison the catalyst of the first electrode 116, according to Reaction (5) below:

CO+Pt(catalyst)→CO−Pt (5)

When section 102a switches to the power generation mode (FIG. 4B), the first electrode 116 no longer interacts with the reformate fuel. Instead, the first electrode 116 interacts with the incoming air from compressor 150 and the product of Reaction (4) above, both of which may include water vapor. The water vapor oxidizes the carbon monoxide to carbon dioxide in an electrochemical water-gas shift reaction, which is set forth as Reaction (6) below, and the reaction products are exhausted from the system.

CO−Pt+H₂O→CO₂+H₂ (6)

It is also within the scope of the present disclosure that the water-gas shift reaction may occur when section 102a is operating in the hydrogen filtration mode (FIG. 4A) due to the presence of water vapor in the reformate fuel. In addition to rejuvenating the first electrode 116, the hydrogen produced by the water-gas shift reaction may be electrochemically pumped across section 102a to produce filtered hydrogen. The water-gas shift reaction may be promoted by the high current supplied to section 102a.

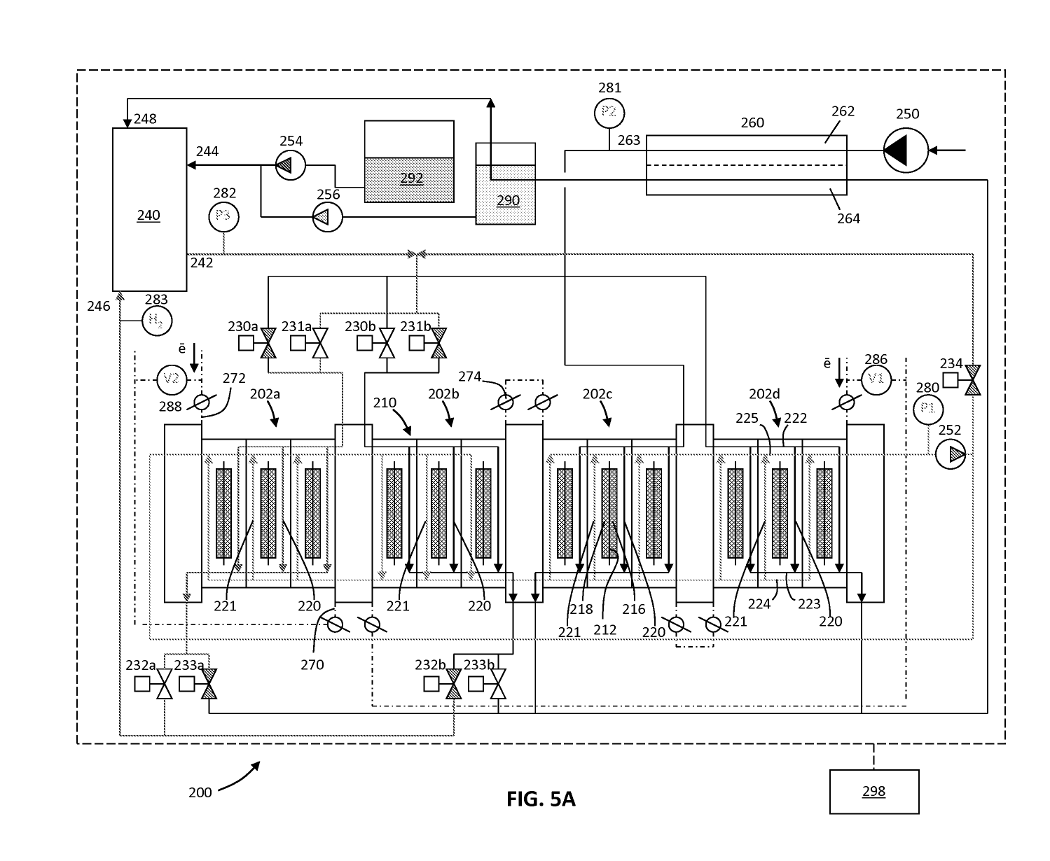

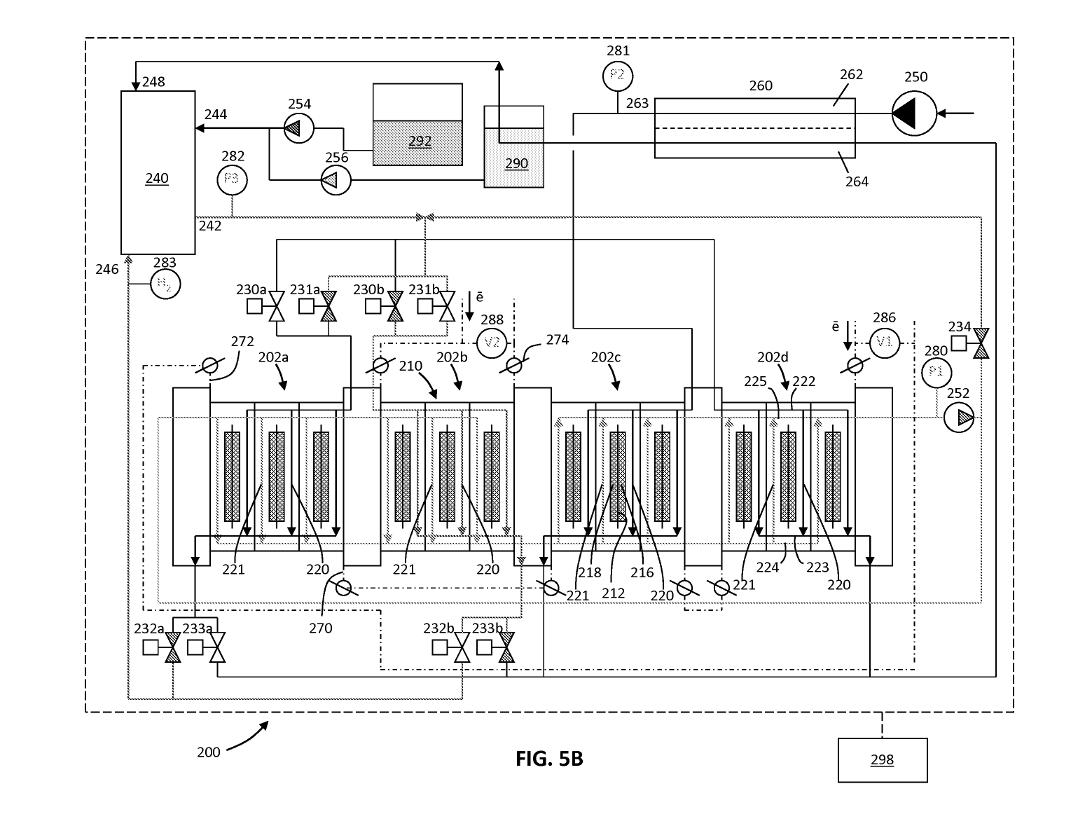

A second fuel cell system 200 is shown in FIGS. 5A and 5B. The second fuel cell system 200 of FIGS. 5A and 5B is similar to the first fuel system 100 of FIGS. 2A and 2B, with like reference numerals indicating like elements, except as described below. Fuel cell system 200 includes a plurality of sections, illustratively four (4) sections 202a, 202b, 202c, 202d.

Sections 202a, 202b, are configured to cycle between the hydrogen filtration mode and the power generation mode, like the above-described sections 102a, 102b, of fuel cell system 100 (FIGS. 2A and 2B). In FIG. 5A, section 202a is shown operating in the hydrogen filtration mode and section 202b is shown operating in the power generation mode. Sections 202a, 202b, switch modes in FIG. 5B, with section 202a now operating in the power generation mode and section 202b now operating in the hydrogen filtration mode. Because sections 202a, 202b, may operate in both modes, the primary flow fields 220 of sections 202a, 202b, are coupled to the air outlet 263 of humidifier 260 via solenoid valves 230a, 230b, to selectively receive the oxygen-rich air, and to the fuel outlet 242 of reformer 240 via solenoid valves 231a, 231b, to selectively receive the hydrogen-rich reformate fuel. Also, the primary flow fields 220 of sections 202a, 202b, are coupled to the burner fuel inlet 246 of reformer 240 via solenoid valves 232a, 232b, to selectively exhaust excess reformate fuel, and to the air exhaust compartment 264 of humidifier 260 via solenoid valves 233a, 233b, to selectively exhaust excess air.

Sections 202c, 202d, on the other hand, behave as conventional fuel cells, operating only in the power generation mode and not in the hydrogen filtration mode. Because sections 202c, 202d, do not receive the hydrogen-rich reformate fuel, the primary flow fields 220 of sections 202c, 202d, are not coupled to the hydrogen-rich fuel outlet 242 of reformer 240. Instead, the primary flow fields 220 of sections 202c, 202d, are permanently coupled to the air outlet 263 of humidifier 260, and may be referred to as air flow fields. Also, because sections 202c, 202d, do not exhaust excess reformate fuel, the primary flow fields 220 of sections 202c, 202d, are not coupled to the burner fuel inlet 246 of reformer 240. Instead, the primary flow fields 220 of sections 202c, 202d, are permanently coupled to the air outlet 263 of humidifier 260.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A fuel cell system for use with a fuel source that supplies hydrogen-rich fuel and carbon monoxide and an air source that supplies oxygen-rich air and water vapor, the fuel cell system comprising:
at least one fuel cell that is selectively operable in a hydrogen filtration mode and in a power generation mode, the at least one fuel cell comprising:
a first electrode;
a second electrode;
a membrane positioned between the first and second electrodes;
a primary flow field adjacent to the first electrode, the primary flow field being selectively coupled to the fuel source in the hydrogen filtration mode such that at least a portion of the carbon monoxide supplied by the fuel source deposits onto the first electrode, the primary flow field being selectively coupled to the air source in the power generation mode such that at least a portion of the water vapor supplied by the air source reacts with the deposited carbon monoxide; and
a hydrogen flow field adjacent to the second electrode.

2. The fuel cell system of claim 1, wherein, in the hydrogen filtration mode, the fuel from the primary flow field filters across the membrane to produce filtered hydrogen in the hydrogen flow field.

3. The fuel cell system of claim 2, wherein the hydrogen flow field directs the filtered hydrogen to another fuel cell operating in the power generation mode.

4. The fuel cell system of claim 1, wherein the water vapor oxidizes the deposited carbon monoxide to produce carbon dioxide.

5. The fuel cell system of claim 1, wherein the membrane is a proton-exchange membrane.

6. The fuel cell system of claim 1, wherein the at least one fuel cell has an operating temperature of about 200° C. or less.

7. The fuel cell system of claim 1, wherein the at least one fuel cell has an operating temperature between about 100° C. and about 200° C.

8. The fuel cell system of claim 1, wherein the fuel source comprises a reformer.

9. The fuel cell system of claim 1, further comprising a second fuel cell that is permanently coupled to the air source to receive oxygen-rich air from the air source.

10. The fuel cell system of claim 1, further comprising:
a voltage sensor that measures the voltage across the at least one fuel cell; and
a controller in communication with the voltage sensor, the controller switching the at least one fuel cell from the hydrogen filtration mode to the power generation mode based on the voltage measured by the voltage sensor.

11. A fuel cell system for use with a hydrogen-rich fuel source and an oxygen-rich air source, the fuel cell system comprising:
a hydrogen recirculation loop;
at least one hydrogen filtration fuel cell comprising:
a first electrode;
a second electrode;
a membrane positioned between the first and second electrodes;
a primary flow field adjacent to the first electrode, the primary flow field having an inlet in communication with the hydrogen-rich fuel source; and
a hydrogen flow field adjacent to the second electrode, the hydrogen flow field having an outlet in communication with the hydrogen recirculation loop to deliver filtered hydrogen to the hydrogen recirculation loop; and
at least one power generation fuel cell comprising:
a first electrode;
a second electrode;
a membrane positioned between the first and second electrodes;
a primary flow field adjacent to the first electrode, the primary flow field having an inlet in communication with the oxygen-rich air source; and
a hydrogen flow field adjacent to the second electrode, the hydrogen flow field having an inlet in communication with the hydrogen recirculation loop and an outlet in communication with the hydrogen recirculation loop.

12. The fuel cell system of claim 11, wherein, from the outlet of the hydrogen flow field of the at least one power generation fuel cell, the filtered hydrogen recirculates in the hydrogen recirculation loop to the inlet of the hydrogen flow field of the at least one power generation fuel cell without traveling to the at least one hydrogen filtration fuel cell.

13. The fuel cell system of claim 11, wherein fuel from the hydrogen-rich fuel source travels to the at least one hydrogen filtration fuel cell before traveling to the at least one power generation fuel cell.

14. The fuel cell system of claim 11, further comprising a hydrogen exhaust line between the hydrogen recirculation loop and the primary flow field of the at least one hydrogen filtration fuel cell and a valve that selectively opens and closes the hydrogen exhaust line.

15. The fuel cell system of claim 14, further comprising a pressure sensor in the hydrogen recirculation loop that controls the valve.

16. The fuel cell system of claim 11, wherein the primary flow field of the at least one hydrogen filtration fuel cell has an outlet in communication with the hydrogen-rich fuel source.

17. The fuel cell system of claim 11, wherein the primary flow field of the at least one power generation fuel cell has an outlet in communication with the hydrogen-rich fuel source.

18. A method of operating a fuel cell system, the fuel cell system including a hydrogen filtration fuel cell having an anode, a cathode, a membrane positioned between the anode and the cathode, and a power source electrically coupled to the cathode, the method comprising the steps of:
directing a hydrogen-rich fuel to the anode of the hydrogen filtration fuel cell, the hydrogen in the fuel dissociating into positively charged hydrogen ions; and
controlling an electrical current between the power source and the cathode to electrochemically pump a proportional number of the positively charged hydrogen ions across the membrane of the hydrogen filtration fuel cell from the anode to the cathode.

19. The method of claim 18, wherein the positively charged hydrogen ions recombine at the cathode to produce filtered hydrogen.

20. The method of claim 19, further comprising the step of directing the filtered hydrogen to a power generation fuel cell.

21. The method of claim 19, further comprising the step of measuring the pressure of the filtered hydrogen in the fuel cell system, wherein the controlling step is based on the measured pressure.
